(19) United States
(12) Patent Application Publication
(10) Pub. No.: US 2006/0242045 A1
(43) Pub. Date: Oct. 26, 2006

(54) Tax attenuation and financing

(76) Inventor: Thomas A. Muldowney, Byron, IL (US)

Correspondence Address: Paul E Schaafsma;NovusIP, LLC, Suite 221, 521 West Superior, Chicago, IL, 60610, US

(21) Appl. No.: 11/114,965

(22) Filed: Apr. 26, 2005

(51) Int. Cl. G06Q 40/00

(52) U.S. Cl. 705/35

(57) ABSTRACT

A method for tax attenuation in accordance with the present invention matches an income stream from an investment to a cost of debt to hold the cost of the tax in abeyance. An amount is invested to gain returns. An amount is borrowed at a cost to pay the tax liability. An investment portfolio is established in order to create a positive spread between the returns on the invested amount and the cost of the borrowed amount such that the periodic returns on the invested amount is sufficient to pay at least the periodic interest payments due on the borrowed amount. In addition, the investment portfolio is established with investments sufficient to cover the margin of the borrowed amount. In addition, the returns of the investment are used to pay interest on the borrowed amount. Finally, the returns of the investment are used to pay off, in full, the amounts borrowed.

### FIELD OF THE INVENTION

The present invention relates to tax attenuation and financing.

### BACKGROUND OF THE INVENTION

Taxes generally fall into two categories: income tax and capital gains tax. While there are a myriad of forms and exceptions, income tax is quite simple: with deductions the very first dollars earned—in effect, those needed for the very basics of life—are free from tax. Everything else is subject to tax at rates that presently rise as high as thirty-five percent (35%). Capital gain tax is only slightly different. Capital gain is the result of investment placed wisely. The invested money hopefully grows. The growth usually comes from a variety of sources—some comes from inflation, some comes from the earnings of the asset itself, and some comes from expectations (not a sure thing) of wealth creation in the future. Some argue that inflation on an asset is merely the markets way of keeping the value of the asset even with regard to purchase power. Thus taxing that part caused by inflation is seen as the taxing of an asset twice. As a result of these and other considerations, the U.S. government has established the tax on the recognition of a capital gain to only fifteen percent (15%).

For assets with a taxable gain, the tax is latent until recognized. That the tax is latent and since the tax must be paid suggests that this is tantamount to a tax lien. Essentially, Federal government holds a tax lien on a part of the gain. For wages earned (all wages, including wages that will be set aside in investment accounts) an income tax will be assessed by the Federal government. The fact that the tax must be paid on wages earned, essentially establishes that the Federal government holds a tax lien on a part of the wages earned.

Tax policy also attempts to motivate human behavior. Some gifts to charities are made purely for altruistic purposes. There is an entire body of academic research that shows people who are clearly altruistic donors, will continue to give even if the special tax treatments (tax deductions) are taken away. Others make gifts to charities only because there is a tax incentive for doing so. Make a gift and you get a tax deduction, thus reducing the amount of tax that you would have otherwise owed. Absent the tax deduction, many gifts to charities would simply ‘go away.’

There is an irony associated with charitable gifts. Taxes confiscate only a portion of your wealth, whereas a gift to a charity ends up costing you the entire gift. For example, if you earn $100 of income, the tax will settle in at a maximum of thirty-five percent (35%). Therefore you keep $65 dollars of cash. In contrast, if you give the $100 to a charity, your taxes will be reduced by $35, but you have to give away the entire $100 to gain the benefit of the $35 tax reduction. It ultimately costs the entire $100. So the ‘gift’ that is the charitable part only cost you $65 because the government was going to take $35 anyway. But at the end of the day, you are still out $100.

One tax-planning vehicle is a charitable remainder trust (CRT). In 1969, the U.S. Congress created this new type of trust to help charities and not-for-profit organizations generate more revenue for their causes. In the past decade, this trust has been steadily gaining in popularity. This vehicle allows taxpayers to reduce estate taxes, eliminate/defer or amortize the tax on capital gains, claim an income tax deduction, and provide a benefit to charities.

CRTs are irrevocable trusts that actually provide for and maintain two sets of beneficiaries. The first set is the income beneficiaries (the trust creator and, if married, a spouse). Income beneficiaries receive a set percentage of income for their lifetime from the trust. The second set of beneficiaries is the named charity. The charity receives the remaining principal of the trust after the income beneficiaries pass away.

In a CRT, assets are transferred now, a charitable deduction is received for a portion of the transfer, and the trust creator or a beneficiary receives income for the rest of their life or a fixed period of time. More particularly, with a CRT assets (cash, securities, etc.) are irrevocably put in a trust. The trust then provides income payments of at least five percent (5%) annually to the trust creator or a named beneficiary. Depending on how the trust is set up, the payments will continue for a fixed period of time, or until the death of the beneficiary. At that time, the remaining assets are transferred from the trust to a charity.

The amount of income paid out each year during the life of the trust depends on whether it is a charitable remainder annuity trust or a charitable remainder unitrust. A charitable remainder annuity trust provides a fixed dollar amount with each payment to the beneficiary. This amount corresponds to a percentage of the original investment paid out annually. For example, a $100,000 charitable remainder annuity trust might pay out seven and a half percent (7.5%) annually. In this situation, the beneficiary would receive $7,500 each year for the lifetime of the beneficiary or a fixed period of years. The $7,500 may be paid in one sum each year, or in several installments throughout the year.

The amount paid annually to the beneficiary of a charitable remainder unitrust is a fixed percentage of the fair market value of the assets, as determined each year. For example, a charitable remainder unitrust might pay out five and a half percent (5.5%) annually. If the assets were valued at $100,000, the beneficiary would receive $5,500 that year (5.5% of $100,000). If the assets were valued at $125,000 the next year, the beneficiary would receive $6,875 (5.5% of $125,000). As with a charitable remainder annuity trust, the payments may be made in one lump sum each year, or in several installments throughout the year.

Because their assets are destined for a charity, CRTs do not pay any capital gains taxes. For this reason, CRTs are ideal for assets like stocks or property with a low cost basis but high-appreciated value. For instance, a rental property is sold for $1 million. Let's assume the original purchase price for the property was $100,000. Upon completion of the sale, capital gains taxes are owed on the $900,000 difference. That tax could easily reach $150,000, depending on how long the property was owned, the taxpayers accumulated depreciation and the taxpayer's overall tax situation. Funding a CRT with highly appreciated assets (like real estate or stock) allows the taxpayer to sell those assets without immediately recognizing the capital gains taxes at the time of the asset sale. Since CRT's have a charitable destination and do not have to pay capital gains, the full value of any assets transfers to the trust (and thus, to a combination of the trust creator's family and his or her favorite charity).

Other common uses of CRTs include diversifying a concentrated stock (or investment) position. Many times investors find that they hold a concentration in appreciated stock. These investors are generally in a good position to hold (and delay the payment of the tax) the stock position unless or until, the position grows to be such a large part of their portfolio. If the position grows to be too large, then the risk character of the portfolio changes for the worse: the investor may simply hold too much stock in one position. If something untoward happens to that company, wealth may be substantially diminished. Recent events demonstrate this danger: Consider the ill fortune to holders of stock of Merck & Co., Inc., 1 Merck Drive, Whitehouse Station, N.J. From a late 2001 stock high of nearly $100 per share, following their withdrawal from the market of their profitable pain and arthritis drug Vioxx Merck stock reached a low of nearly $25 per share. Holders of stock of energy firm Enron Corp., Four Houston Center, 1221 Lamar, Suite 1600, Houston, Tex. suffered as well. From an early 2001 high of over $80 per share, following corporate and accounting scandals Enron became largest bankruptcy in U.S. history. Witness too the major crash of the values of stocks in the technology and tech-sector. In the late 1990s the tech sector financial markets grew at an astonishing rate. The technology-rich NASDAQ stock index reached a March 2000 high of 5047.69. Many people would have sold out of their gains positions except for the reality of the tax on the capital gain that they would have incurred. Because of this tax, they held fast to their positions. When the Internet valuation bubble burst in March 2000 through the end of February 2003, the gains had been washed away.

While they have clearly enjoyed the benefit of tax deferred investment growth, these investors knew that they would be better off if they held a diversified investment portfolio rather than a concentrated stock position. The thing that stops them from protecting themselves is that the sale and subsequent diversification will cause a tax on the capital gain. Holding the position avoids the tax but at the extreme risk of having something bad happen to the concentrated stock position

Many people use hybrid Charitable Remainder Trusts, called NIMCRUT's (Net Income with Makeup Charitable Remainder Unitrust), to augment current retirement plans. By setting one up in peak earning years, the trust beneficiary can make contributions to the CRT in the form of zero coupon bonds, non-dividend paying growth stocks or professionally managed variable annuities. By letting the CRT grow without taking income from it during the early years, the asset can grow without exposure to income tax. At retirement CRT can begin making periodic payouts. These payouts can include makeup for any shortfalls in income not received earlier. Unlike IRAs or 401(k) plans, there are no limits on how much can be contributed. However, as previously noted, the eventual gift to a charity ends up costing the entire gift.

Another series of tax planning vehicles were established under the Employee Retirement Income Security Act (ERISA). In 1974, Congress set minimum standards for most voluntarily established pension and health plans in private industry to provide protection for individuals in these plans. ERISA requires plans to provide participants with plan information including important information about plan features and funding; provides fiduciary responsibilities for those who manage and control plan assets; requires plans to establish a grievance and appeals process for participants to get benefits from their plans; and gives participants the right to sue for benefits and breaches of fiduciary duty.

In general, ERISA does not cover group health plans established or maintained by governmental entities, churches for their employees or plans which are maintained solely to comply with applicable workers compensation, unemployment or disability laws. ERISA also does not cover plans maintained outside the United States primarily for the benefit of nonresident aliens or unfunded excess benefit plans.

Thus, ERISA created an environment in which business owners and individuals could save for retirement, obtain a current deduction from income tax for the amount saved, control the assets, defer the taxes on both the deposit and the gains until the funds are withdrawn in retirement, and create an environment to reward productive/loyal employees. However, these benefits come with several restrictions, including that an employer must make cash deposits for their employees. An employer cannot use the retirement plan to incent only productive employees: all employees must be included. An investor cannot preferentially shift the deferred tax until low tax years, the tax deferral may cause income to shift from low wage tax years to higher tax years in retirement. An investor cannot ‘pre-pay’ the tax even if it is advantageous to do so; if funds are taken out prior to a magical age—59½—both ordinary and punitive taxes must be paid. An investor must begin to take funds out for all years after age 7½, although a few exceptions apply. Investors cannot borrow on their own retirement account; at death, the income tax must still be paid, usually by their heirs. And for some plans, once the plan is started, an investor must maintain it for several years even if future years are not a profitable as other years. For many entrepreneurs, it is not uncommon to get a large a windfall of revenue for a single year; for these employers, there is no way for them to shelter themselves from the maximum tax rate.

Additional vehicles in which individuals can be overexposed to risk because of tax consequence include non-qualified stock options (NQSO) and incentive stock options (ISO). In an NQSO, a company grants an employee an option to purchase shares of stock at a fixed price. The price is usually at or below the price the stock is trading for at the time the option is granted. The option typically lapses on a certain date. The incentive to the employee is to participate in the potential increase in value of the stock of his employer's stock without having to risk a cash investment. Since this arrangement is a form of compensation, the employee generally must report ordinary income when the option is exercised. The amount of ordinary income is the excess of the fair market value of the shares received over the option price. The reason these options are called “non-qualified” is they do not qualify for special treatment of incentive stock options and are taxed as ordinary income. ISOs are only available for employees. Other restrictions apply for them. For regular tax purposes, incentive stock options have the advantage that no income is reported when the option is exercised and, if certain requirements are met, the entire gain when the stock is sold is taxed as long-term capital gains.

What is thus needed is a method to attenuate the tax liability that does not suffer from the drawbacks of these prior art vehicles. It would also be advantageous to provide for an improved method for financing.

### SUMMARY OF THE INVENTION

A method in accordance with the principles of the present invention supplants the tax liability but does not suffer from the drawbacks of these prior art vehicles. A method in accordance with the principles of the present invention provides for an improved method for financing. A method in accordance with the present invention matches an income stream from an investment to the cost of debt. An amount is invested to generate investment returns. An amount is borrowed at a cost to pay the tax liability, thus the tax is fully paid at the time of recognition but without the diminishment of the investments earning power. An investment portfolio is established in order to create a positive cash flow spread between the returns on the invested amount and the cost of the borrowed amount such that the periodic return on the invested amount is sufficient to pay at least the periodic interest payments due on the borrowed amount. In addition, the investment portfolio is established with investments sufficient to cover the margin loan of the borrowed amount. Finally, the returns of the investment are used to re-pay the loan of the borrowed amount

### BRIEF DESCRIPTION OF THE DRAWINGS

FIG. 1 is a spreadsheet overview of a taxpayer paying the full ordinary federal income tax.

FIG. 2 is a spreadsheet overview of the taxpayer of FIG. 1 utilizing a method in accordance with the principles of the present invention.

FIG. 3 is a spreadsheet overview of a taxpayer who has an event causing the recognition of a large capital gain paying the attendant federal tax on capital gain.

FIG. 4 is a spreadsheet overview of the taxpayer of FIG. 3 utilizing a method in accordance with the principles of the present invention.

FIG. 5 is a spreadsheet overview of a taxpayer utilizing a method in accordance with the principles of the present invention to finance college expenses.

### DETAILED DESCRIPTION OF THE INVENTION

In one embodiment in accordance with the principles of the present invention, a method for tax attenuation is provided. In one aspect of the present invention, a leveraging technique is utilized to pay tax liabilities. Investments are designed to generate sufficient revenues to cover the costs of the interest on a loan taken out to pay the tax liability. A method for tax attenuation of the present invention comprises the matching of the income stream necessary to match the cost of debt to hold the tax (cost) in abeyance.

In more detail, a method in accordance with the present invention matches an income stream from an investment to a cost of debt. An amount is invested to gain returns. An amount is borrowed at a cost to pay the tax liability. An investment portfolio is established in order to create a positive cash flow spread between the returns on the invested amount and the cost of the borrowed amount such that the periodic returns on the invested amount is sufficient to pay at least the periodic interest payments due on the borrowed amount. In addition, the investment portfolio is established with investments sufficient to cover the margin of the borrowed amount. Finally, the returns of the investment are used to pay interest on the borrowed amount

Factors such as the risk and return of the investment and use of the invested amount as collateral for the borrowing can be used to establish an appropriate spread. A method in accordance with the present invention can be utilized in response to a taxable event, can be utilized in response to a taxable capital gain or can be utilized to finance borrowing an amount for which the returns of the invested amount are sufficient to pay interests on the borrowed amount.

The method for tax attenuation of the present invention has multiple applications. For example, a method for tax attenuation of the present invention creates a viable alternative to a charitable remainder trusts plan. Unlike a charitable remainder trust, under a method for tax attenuation of the present invention the remaining assets are retained by the investor instead of being transferred from the trust to a charity.

In an additional example, a method for tax attenuation of the present invention creates a viable alternative to an ERISA plan. In an ERISA plan the full amount withdrawn from the ERISA plan in the future will be taxed as full ordinary income—even if the gain came from investment gains or dividends. Under the current tax laws, in a non-ERISA account, dividends or gains are taxed at a much more favorable capital gain tax rate. A method in accordance with the present invention can be used as a substitute for ERISA plans (thus paying the full initial ordinary income tax) thus allowing the investment to grow. When finally recognized, the gain will be taxed at more favorable capital gains tax rates. In addition, the taxpayer enjoys several other benefits: The taxpayer may commit all dividends to pay off the interest and, over time, the loan principal.

As the method for tax attenuation of the present invention opens countless opportunities for beneficial applications, more applications will be apparent to those skilled in the art.

By using a method of the present invention an investor can start an accumulation plan for themselves, be free from government regulations as to how much can be accumulated, be free from government regulations regarding the inclusion of employees and the investor can pay off the tax over time using either the revenues generated by the investments themselves or cash money from other sources. This can be done with minimal costs of administering the plan. Plan contributions do not have to be made for unproductive employees. Further, the method for tax attenuation of the present invention can be engaged to coincide with a business cycle; if an entrepreneur for example earns variable income in different years, having the opportunity to invest via the method for tax attenuation of the present invention on an ad hoc basis creates additional relief. Borrowing to fund a retirement plan (otherwise facing penalties or disqualification) will not be required. Thus, the method for tax attenuation of the present invention creates an alternative to the regimented, regulated, and costly ERISA based retirement plans.

The method of tax attenuation of the present application replaces the governmental tax lien with a lien held by a commercial lender. The lien held by a commercial lender compares to the same tax lien that exists in regards to a qualified retirement plan (an ERISA plan) in that the taxes on contributions are merely deferred. The lien held by a commercial lender also compares to the same tax lien that exists in regards to investment gains and earnings in a qualified retirement plan (an ERISA plan) in that the taxes on gains and earnings are merely deferred.

To better understand a method of the present invention, several aspects of the financial marketplace need to be understood. Some of the money earned by a wage earner is consumed for life support and for lifestyle expenses. The money consumed for life support and lifestyle support ceases to exist when spent (for example, cash money spent on dinner ceases to exist for the wage earner as soon as he/she pays for his dinner). He has nothing to show for it except the wasting asset, his dinner.

Some of the money earned by a wage earner and not consumed is available for savings and investment. Money invested has the ability to generate or regenerate itself. Money invested has a future. Because money can generate its own revenue, and the tax it causes is usually not due until the next year, invested money can pay the tax by its own revenue generation over time; that is, to amortize the tax payment thus preserving future asset generation. Money invested (and not consumed) can generate additional money that can be used for consumption, paying off loans or reinvested for growth.

Typically, tax is payable at the end of the year in which it was generated. This is also true for capital gain recognized in the year of an asset sale. This creates an interesting dichotomy. Because money can generate its own revenue, and the tax it causes is usually not due until the next year, invested money can pay a part of the current tax due by its own revenue generation. Over time this money has the ability to completely amortize the tax payment thus preserving future asset generation. Money invested (and not consumed) can generate additional money that can be used for consumption, paying off loans or reinvested for growth.

A method in accordance with the present invention asks the question: if we finance other capital transactions, why not finance the ultimate capital transaction, the accumulation of money? And, a method in accordance with the present invention allows a further enhancement, acquired money properly invested generates annual cash flow. This allows us to let the capital acquired, pay its own tax by financing the tax over time.

A method in accordance with the present invention recognizes and creates the means by which some capital assets have the ability to regenerate themselves in the form of revenues (for example, dividends, interest and growth). Taxes reduce the amount of money left over for regeneration. A method in accordance with the present invention preserves the original amounts of monies available for investment, therefore creating more opportunity for regeneration. Since it costs money to borrow money, in the early years of a method in accordance with the present invention, the earned dividends and earned interest is used to pay for the cost of money (borrowed interest) and for amortization of the loan principal. By using a method in accordance with the present invention, more money is available to regenerate. This increase in invested money when combined with the remaining investment is used to produce revenues (for example, dividend and interest). These revenues are sufficient to pay interest on the cost of money and are also sufficient to amortize the loan principal.

A method in accordance with the present invention improves over the drawbacks of the prior art by enabling several things. The government already holds a lien on wages or on the gain of an investment: tax. A method in accordance with the present invention allows an investor to:
Get rid of the government as a lien holder and replace it with a commercial lien holder.
Sell a concentrated position thus recognizing the tax at rates that are relatively low.
Diversify a concentrated investment position thus reducing the risk.
Invest for cash flow sufficient to amortize the tax/lien.
Amortize the tax lien over a period of years.
Invest for retirement cash flow or investment growth.
Prepay some or all of the tax—this is not an option with an ERISA plan.

A method in accordance with the present invention creates an environment where the heretofore assumption that the tax must be paid in one lump sum at the time that the gain is recognized is vanquished and is instead replaced with a system to amortize the tax lien over the time. A method in accordance with the present invention creates an environment in which the investor is encouraged to invest and keep on investing. As more and more is accumulated, an increasing cash flow is created that can reduce debt and create the opportunity to do even more.

Several factors support the confidence in the success of a method in accordance with the present invention:
Confidence that periodic dividends will be paid.
Confidence that periodic bond interest will be paid.
Wise matching of investment revenue generation with the cost of money borrowed.
Limits and ratios to provide confidence that margin calls will not jeopardize the investment position.
   An often used goal of tax management is to eliminate, reduce convert, or at the very least to defer tax payments into the future. This is especially beneficial if the investor expects to be in a lower tax bracket in the future. However, a relatively low tax environment exists now, certainly considering historical tax rates. A method in accordance with the present invention recognizes that paying the tax now, thus gaining control of the asset, creates a position of wealth without having the threat of a future tax increase. A method in accordance with the present invention enables the taxes to be paid in a low tax environment now but do so with the added privilege of amortizing the taxes over a period of years, usually while the taxpayer is still earning a wage. By using the applications of a method in accordance with the present invention, even if the tax rates of the future are increased, the taxpayer presently enjoys the benefit of having frozen taxes at today's rate, the benefit of being able to amortize tax payments over time, and the benefit of being less concerned with the matters of a higher tax rate in the future. The tax will have been frozen in the present time period, thus reducing total tax in two instances—once by amortization and a second time by pre-paying the tax at the lower tax rate.

There are a series of ratios that are important in using a method in accordance with the present invention. One of the ratios is the allocation between equity (for example, stocks) and debt (for example, bonds). This ratio is important because the ratio is responsible for the volume of dollars that will be generated annually (or periodically)—it is the cash flow generated by the investment pool that will cover the cost of money (interest on the debt). Another ratio is the ratio of dividends generated by the stocks. The rate generated by the stocks of the S&P 500® index for example hovers in range of one and one half percent (1.5%). The S&P 500® index S&P 500® index is disseminated by Standard & Poor's, 55 Water Street, New York, N.Y. 10041.

Separately from this, there is a ratio of assets that must be considered to cover the margin loan itself. In general, you will be in a much safer position (lower risk of margin call) if you use a multiple that is larger than the ratio necessary to cover the margin via the investment house rules. (Typically, an investment house will allow you to carry a loan as high as 65% of the account value.)

Let's look at a few ratios. We start with the assumption that some saved money resides in a standard, taxable investment portfolio. Let us suppose that the 100% stock portfolio generates a dividend of 1.25% per year. Generally, when stocks (that is, an individual company) pays a dividend, it generally continues to do so. If the stock value never fluctuated, and the dividend rate stayed constant, you could always rely on that portfolio to generate 1.25% per year. Let's further suppose that the stocks add up to a total of $36,000. $36,000 in stocks will generate $450 of annual dividends.

Next, let us suppose that the stockowner desires to take a vacation that will cost $10,000. The stockowner has (at least) two choices. The stockowner could sell of part of the investment portfolio and use the proceeds to pay for the event or the stockowner could borrow $10,000 from an investment broker. Alternative, the stockowner could use a method in accordance with the present invention to cover the cost of the vacation. Let us also assume that the current cost of money (interest) is 4.5% per annum. $10,000 at 4.5% will suffer an annual cost of $450.00. Notice that the dividends—$450 per year—are matched to the interest cost of $450. In this simple illustration, the assets are perfectly matched.

If interest rates never changed and stock values never changed and dividends never changed, the dividends earned would always match the annual cost. This might be described as a perpetual standoff: the portfolio would never change, the net financial position would never change, and the stock owner would perpetually have a $10,000 debt that would never have to paid off. The benefit to the stockowner? A $10,000 vacation.

We can now introduce another variable. Suppose that on a periodic basis, money is added to the investment account. Assume that an additional $4,000 is added to the original $36,000 of investment money. Doing so increases the annual dividend being generated by the portfolio. Instead of generating $450 of dividends, the portfolio now generates $500 of dividend. The extra $50 of dividend can reduce the debt from $10,000 to $9,950 and also reduces the annual interest cost from $450 to $447.50. Notice here that we have now created a ‘spread’ between the cost of money and that generated by the investment portfolio. This additional interest being earned, when combined with the decline in the actual cost of money, begins the process of debt amortization. Next year, if/when more money is added to the investment account, the capability of the portfolio to pay off the debt is enhanced.

Thus, a method in accordance with the present invention helps taxpayers reduce a variety of risks:

If used to cover tax on capital gain, the taxpayer enjoys more freedom to liquidate the concentrated position of holding a single stock issue. The resulting diversification reduces the investment risk.
If used as an ERISA substitute, the investor reduces the risk of an increase in federal income tax in the future—and the investor enjoys the ability to tax gain and dividends at the favorable capital gains tax rate of (presently) fifteen percent (15%).
If used as a device with which to exercise an employer awarded stock option, the employee may enjoy the exercise of the option without having to make a payment of money or money's worth.
If used to acquire option stock and with the passage of time (1 year) to qualify for long term capital gain treatment, the position may be diversified.

As known in the art, a method in accordance with the principals of the present invention can be preferably embodied as a system cooperating with computer hardware components, and as a computer-implemented method.

The following are non-limited examples of uses of method in accordance with the present invention.

### EXAMPLE 1

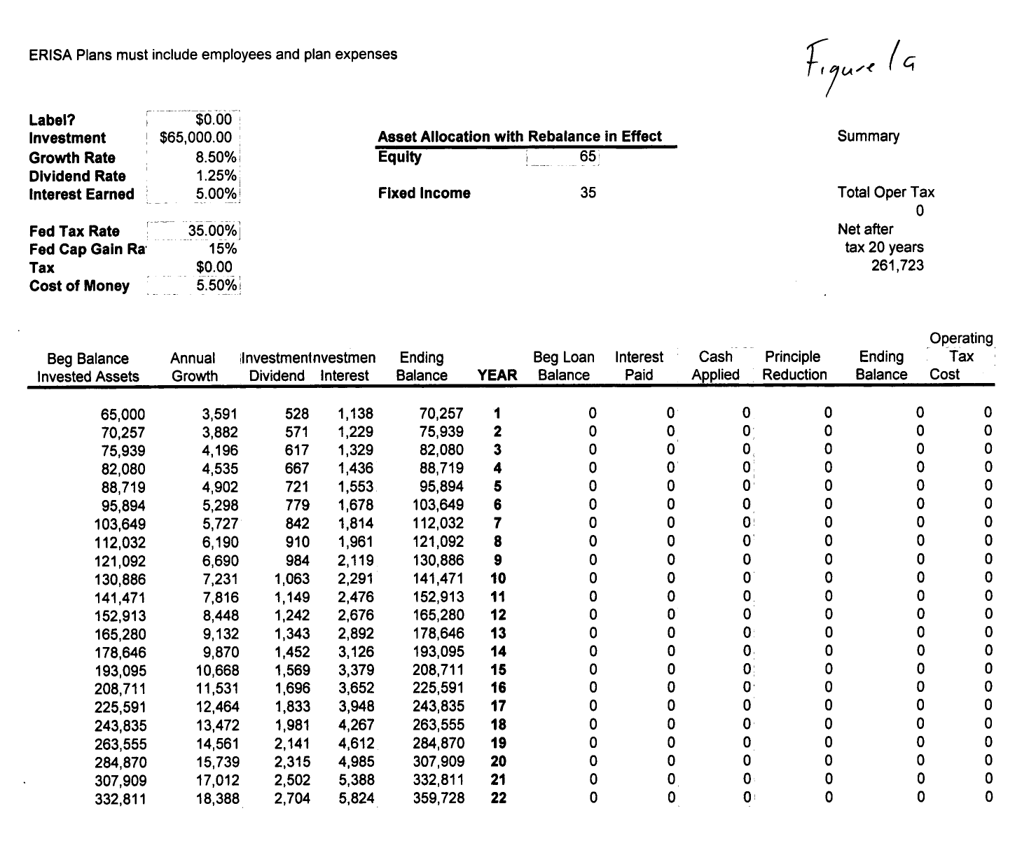

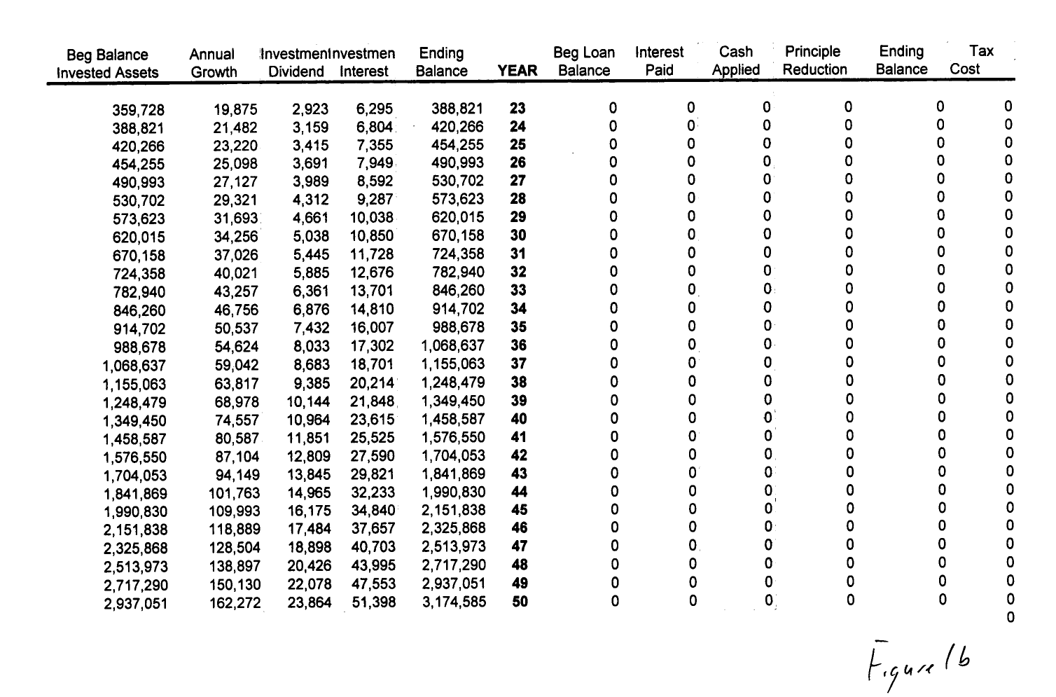

Referring to FIG. 1, a taxpayer pays the full ordinary federal income tax and, after paying the tax, the taxpayer has only 65% of his original wage left over to invest. More particularly, assume that the top dollars earned are in the 35% tax bracket and that the investor desires to save $100,000. In accordance with the tax liability, approximately 35% or $35,000 of tax liability is paid, leaving $65,000 to be invested. Assume that 65% is invested in equity and 35% in fixed income. Assuming an equity growth rate of 8.50%, a dividend rate of 1.25%, and a bond interest rate of 5.00%. It is seen that at the end of the tenth year, the $65,000 investment has grown to $141,471; at the end of the 20^{th} year $307,090; and at the end of the 50^{th} year $3,174,585.

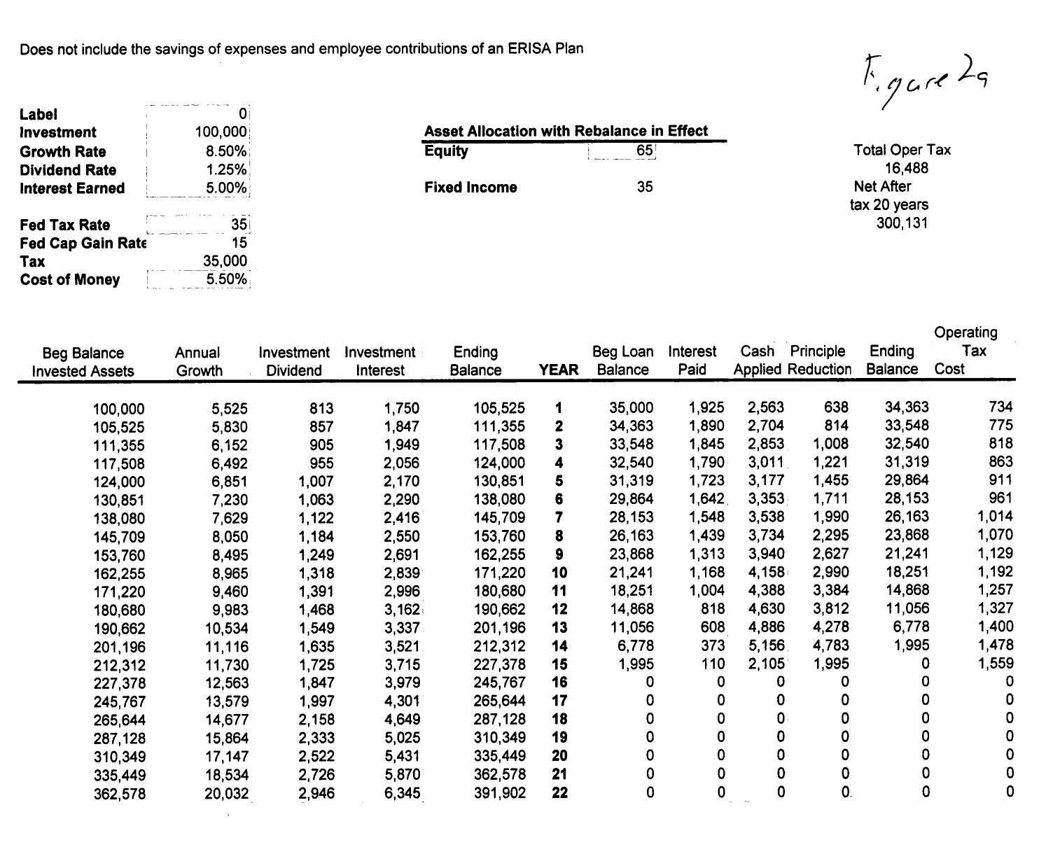

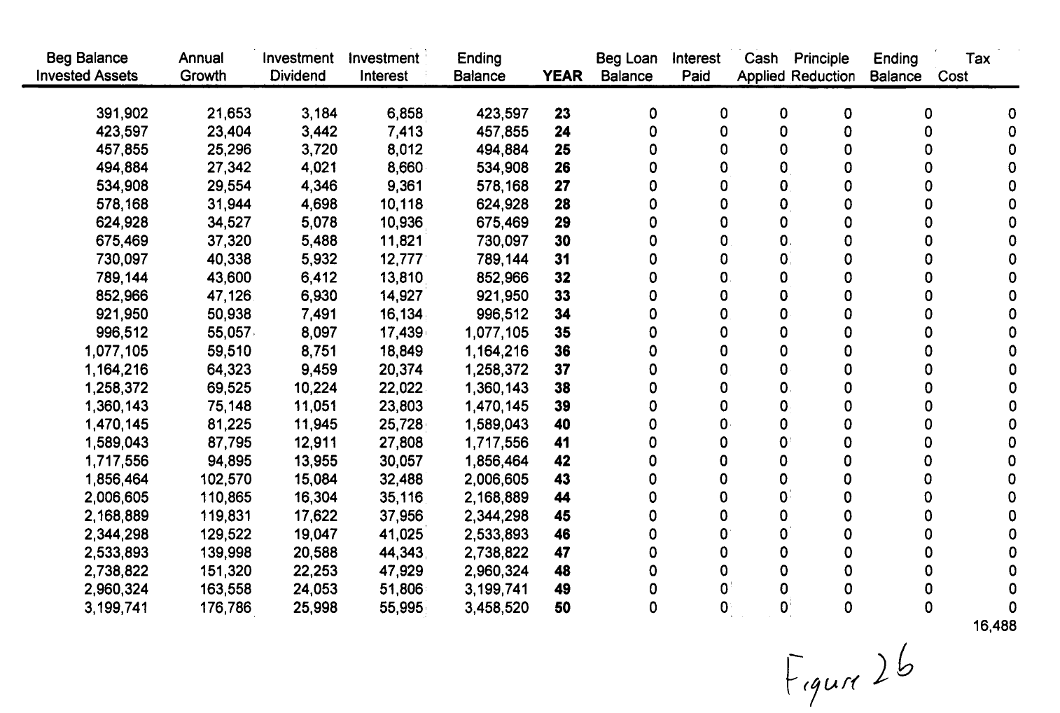

In FIG. 2, instead of paying the federal income tax from the earned wage the entire amount of the wage is invested and the amount of the tax is borrowed, with the investment account serving as collateral for the loan. Again, the percent invested in equity, the percent invested in fixed income, the equity growth rate, the dividend rate, and the interest rate are the same as in FIG. 1. Assume that the secured loan costs 5.5%. At the end of the first year, the $65,000 equity investment has earned $5,525, a dividend of $813; and the $35,000 fixed income investment has earned interest of $1,750. The $35,000 loan requires an interest payment of $1,925. All of the fixed income interest and the stock dividend earnings of $2,563 ($1,750 plus $813) are applied to the loan, paying off the interest with a $638 reduction in the loan. The tax (paid on the dividend at the capital gains rate and paid on the interest at the ordinary income rate) is $734. This annual tax cost is paid in cash from wage earnings.

Continuing this pattern, by the end of the 10^{th} year the $100,000 has grown to $171,220 and the loan balance at the end of the 10^{th} year has been reduced to $18,251. In the 20^{th} year, the $100,000 has grown to $335,449 and the loan balance at the end of the 20^{th} year is paid off. The total tax which was paid in annual payments from earned income, thus paid is $16,488. At the end of the 50^{th} year, the $100,000 has grown to $3,458,520.

The difference in the amount of growth at the end of the 20^{th} year between these two scenarios is ($335,449−307,909) is ($27,540). Surprisingly, however, the net after tax in the first scenario at the end of the 20^{th} year is $261,723 while the net after tax for the second scenario at the end of the 20^{th} year is $300,131. Thus, the second scenario at the end of the 20^{th} year created $38,408 of wealth.

### EXAMPLE 2

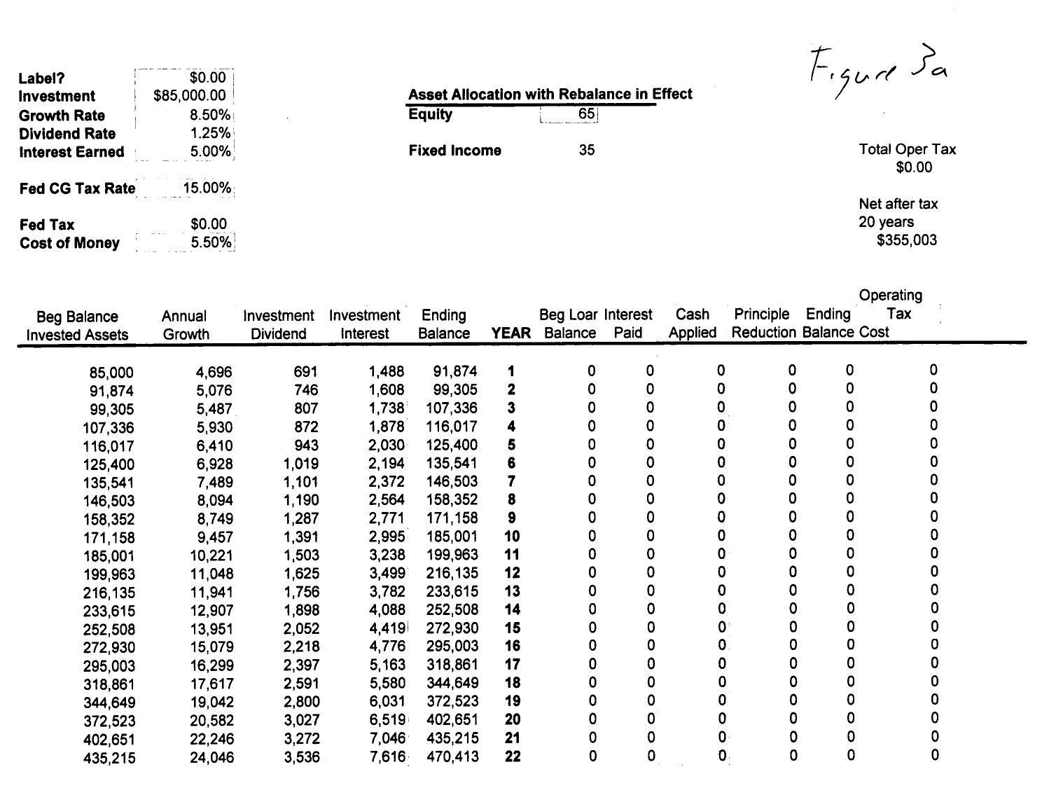

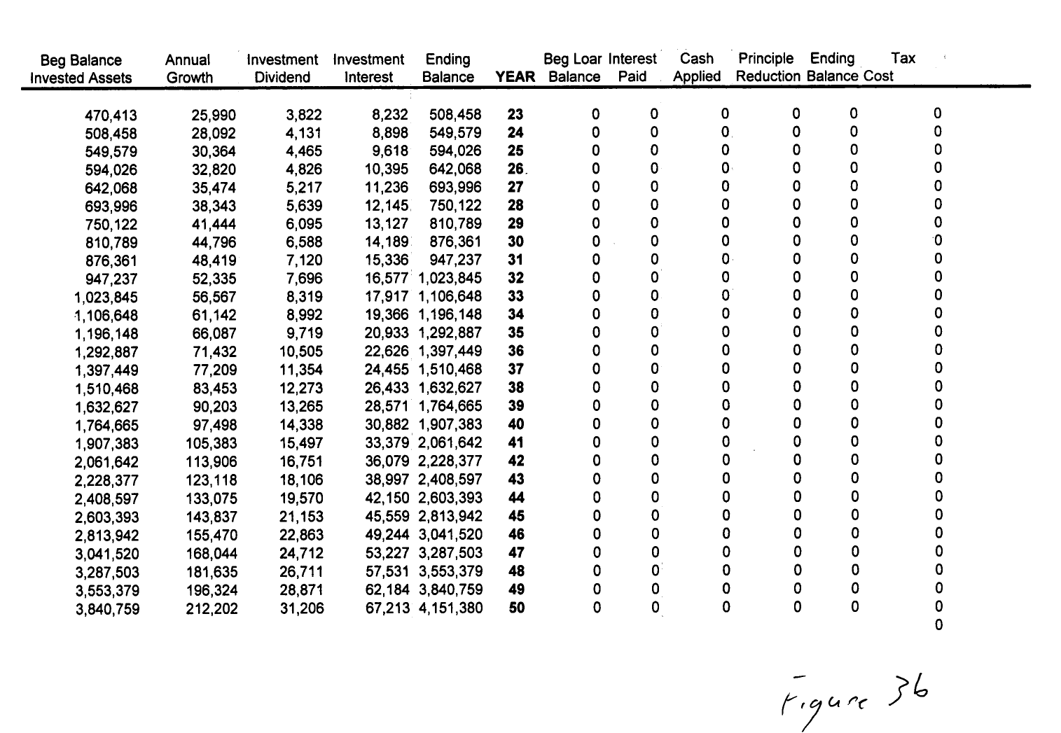

Referring to FIG. 3, a taxpayer has an event causing the recognition of a large capital gain and must suffer the attendant federal tax on capital gain. After paying the tax, the taxpayer has only 85% of his original gain left over to invest. More particularly, assume a capital gain of $100,000 is realized. In accordance with the tax liability, approximately 15% or $15,000 of tax liability is paid, leaving $85,000 to be invested. Assume that 65% is invested in equity and 35% in fixed income. Assume an equity growth rate of 8.50%, a dividend rate of 1.25%, and an interest rate of 5.00%. It is seen that at the end of the tenth year, the $85,000 investment has grown to $185,001; at the end of the 20^{th} year $402,651; and at the end of the 50^{th} year $4,151,380.

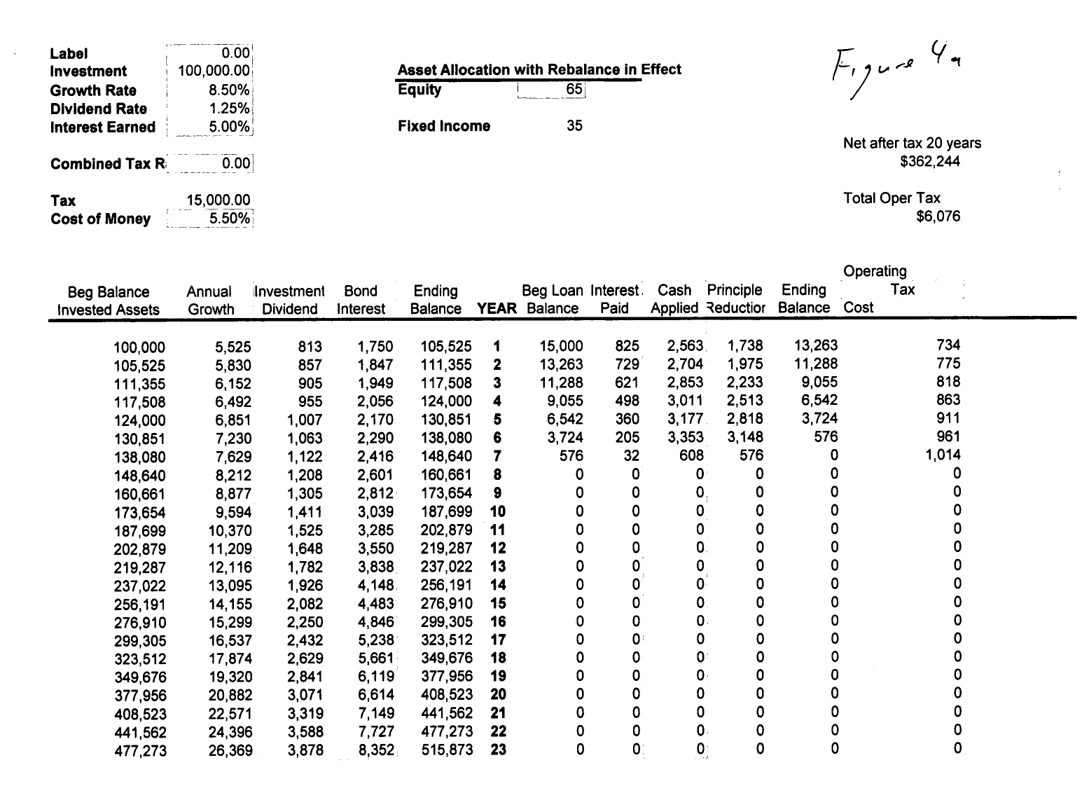

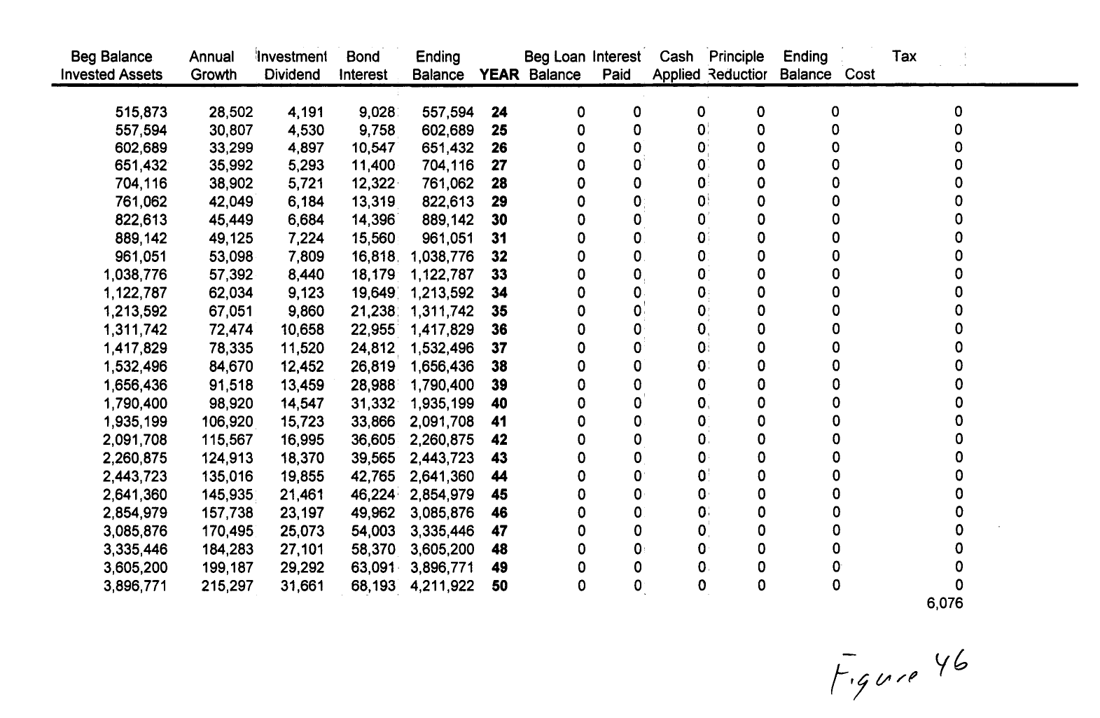

In FIG. 4, instead of paying the federal capital gains tax from the capital gains the entire amount of proceeds is invested and the amount of the tax is borrowed, with the investment account serving as collateral for the loan. Again, the percent invested in equity, the percent invested in fixed income, the equity growth rate, the dividend rate, and the interest rate are the same as in FIG. 3. Assume that the secured loan costs 5.5%. At the end of the first year, the $65,000 equity investment has earned $5,525 and a dividend of $813; the $35,000 fixed income investment has earned interest of $1,750. The $15,000 loan requires an interest payment of $825. All of the cash income investment earnings of $2,563 ($1,750 plus $813) is applied to the loan, paying off the interest with a $1,738 reduction in the loan. The annual tax paid on the dividends and interest earned is $734.

Continuing this pattern, by the end of the 7^{th} year the $100,000 has grown to $148,640 and the loan balance at the end of the 7^{th} year is paid off. The total tax thus paid in annual installments from wage earnings is $6,076. At the end of the 50^{th} year, the $100,000 has grown to $4,211,922.

The difference in the amount of growth at the end of the 20^{th} year between these two scenarios ($408,523−$402,651) is $5,872. Surprisingly, however, the net after tax in the first scenario at the end of the 20^{th} year is $355,003 while the net after tax for the second scenario at the end of the 20^{th} year is $362,244. Thus, the second scenario at the end of the 20^{th} year created $7,241 of additional wealth.

### EXAMPLE 3

Many parents fret about how much money they must save or allocate for payment of college expenses. When the kids get to college, the parents simply brace themselves and pay it—either out of finds that they set up in the kids name or out of their own funds. A method in accordance with the present invention allows the user to set ratios as savings targets that can serve dual purposes. Through a method in accordance with the present invention funds can be used to meet college-funding needs and retirement independence needs at the same time.

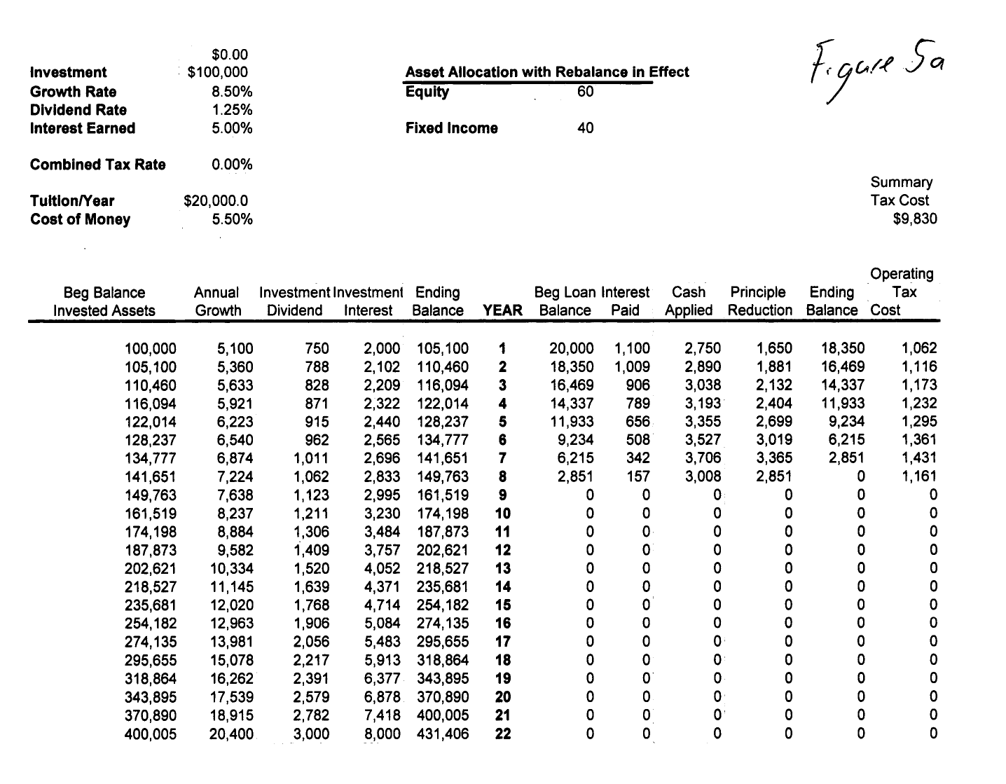

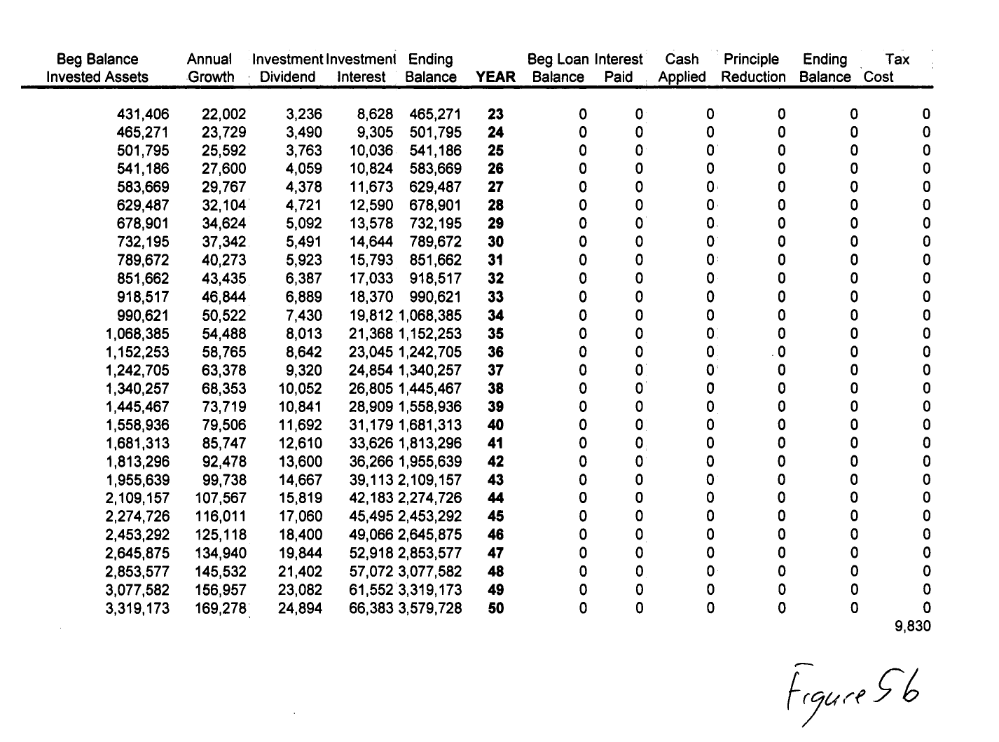

Referring to FIG. 5, a taxpayer asks the question, how much money must I have on hand to use a method in accordance with the present invention as a device from which to pay college expenses for one year if the tuition is $20,000? The taxpayer borrows the $20,000 at 5.50% and invests $100,000. Assume that 60% is invested in equity and 40% in fixed income. Assume an equity growth rate of 8.50%, a dividend rate of 1.25%, and an interest rate of 5.00%. All of the fixed income investment earnings are applied to the loan. It is seen that at the end of the eighth year, the $100,000 investment has grown to $149,763 and the loan balance is paid off. The total operating tax (the sum of the annual tax costs for implementing the plan) is $9,830.

While the invention has been described with specific embodiments, other alternatives, modifications and variations will be apparent to those skilled in the art. One example is highly compensated individuals such as for example professional athletes. These individuals earn gigantic sums of annual income while they are at the apogee of their career are ineligible to save any meaningful dollar amounts in a qualified ERISA plan. As further examples, TV stars, professional actors, singers and performers earn so much money they feel comfortable paying substantial taxes, but they simultaneously run the risk of a career destroying broken bone or being replaced by the next beauty queen or superstar. Keeping hold of some of the money that would otherwise be spent on taxes, allows them to maintain their superstar status, at least financially long after their career burst may have expired. Accordingly, it will be intended to include all such alternatives, modifications and variations set forth within the spirit and scope of the appended claims.

What is claimed is:

1. A method comprising:
investing an amount to gain returns;
at a cost of such borrowed amount, borrowing an amount for which the returns of the invested amounts are sufficient to pay interest costs on the borrowed amount;
establishing a positive spread between the cash flow returns on the invested amount and the cost of the borrowed amount; and
applying at least a portion of the cash flow returns of the investment to pay at least the interests on the borrowed amount.

2. The method of claim 1 further including utilizing the invested amount as collateral for the borrowing.

3. The method of claim 1 further including investing the amount in a portfolio of equity and fixed income.

4. The method of claim 3 further including investing the amount in a portfolio of equity and fixed income of such profile as to enable the periodic returns on the invested amount is sufficient to pay at least the periodic interest payments due on the borrowed amount.

5. The method of claim 1 further including investing the amount in a portfolio of equity and debt instruments.

6. The method of claim 5 further including investing the amount in a portfolio of equity and debt instruments of such profile as to enable the periodic returns on the invested amount is sufficient to pay at least the periodic interest payments due on the borrowed amount.

7. The method of claim 5 further including investing the amount in a portfolio of stock and bonds.

8. The method of claim 7 further including investing the amount in a portfolio of stock and bonds of such profile as to enable the periodic returns on the invested amount is sufficient to pay at least the periodic interest payments due on the borrowed amount.

9. The method of claim 1 further wherein the returns on the invested amount comprise returns elected from the group comprising dividend, interest, appreciation, and combinations thereof.

10. The method of claim 1 further wherein the periodic returns on the invested amount is sufficient to pay the interest plus a portion of the borrowed amount.

11. The method of claim 1 further including establishing a portfolio of investments sufficient to cover the borrowed amount margin.

12. A method comprising:
upon an occurrence of a taxable event, investing an amount of the taxable event to gain returns;
at a cost of such borrowed amount, borrowing an amount to pay at least a portion of the tax liability;
establishing a positive cash flow and growth spread between the returns on the invested amount and the cost of the borrowed amount; and
applying at least a portion of the cash flow returns of the investment to pay interest on the borrowed amount.

13. The method of claim 12 further including utilizing the invested amount as collateral for the borrowing.

14. The method of claim 12 further including investing the amount of the taxable event in a portfolio of equity and fixed income.

15. The method of claim 14 further including investing the amount of the taxable event in a portfolio of equity and fixed income of such profile as to enable the periodic cash flow and growth returns on the invested amount is sufficient to pay at least the periodic interest payments due on the borrowed amount.

16. The method of claim 12 further including investing the amount of the taxable event in a portfolio of equity and debt instruments.

17. The method of claim 16 further including investing the amount of the taxable event in a portfolio of equity and debt instruments of such profile as to enable the periodic returns on the invested amount is sufficient to pay at least the periodic interest payments due on the borrowed amount.

18. The method of claim 16 further including investing the amount of the taxable event in a portfolio of stock and bonds.

19. The method of claim 18 further including investing the amount of the taxable event in a portfolio of stock and bonds of such profile as to enable the periodic cash flow and growth returns on the invested amount is sufficient to pay at least the periodic interest payments due on the borrowed amount.

20. The method of claim 12 further wherein the returns on the invested amount comprise returns elected from the group comprising dividend, interest, appreciation, and combinations thereof.

21. The method of claim 12 further wherein the periodic cash flow and growth returns on the invested amount is sufficient to pay the interest plus a portion of the borrowed amount.

22. The method of creating a financial instrument of claim 12 further including establishing a portfolio of investments sufficient to cover the borrowed amount margin.

23. The method of creating a financial instrument of claim 12 further wherein the taxable event is wage earnings.

24. The method of creating a financial instrument of claim 12 further wherein the taxable event is capital gains.

25. A method for tax attenuation comprising matching an income stream from an investment to a cost of debt to hold the cost of the tax in abeyance.

26. The method for tax attenuation of claim 25 further wherein the income stream from the investment is sufficient to pay the cost of debt.

27. The method for tax attenuation of claim 25 further including establishing a positive cash flow and growth spread between the income stream from the investment and the cost of debt.

28. The method for tax attenuation of claim 25 further including utilizing the investment as collateral for the debt.

29. The method for tax attenuation of claim 25 further wherein the income stream from the investment is sufficient to pay the cost of debt plus a portion of the debt.

30. The method for tax attenuation of claim 25 further including establishing a portfolio of investments sufficient to cover the debt margin.
